(19) United States
(12) Patent Application Publication
(10) Pub. No.: US 2015/0093524 A1
(43) Pub. Date: Apr. 2, 2015

(54) STRUCTURE COVER

(71) Applicant: Franke Technology and Trademark Ltd, Hergiswil (CH)

(72) Inventors: Dan Chris Pulos, Thousand Oaks, CA (US); Ariel H. Minguez, La Canada, CA (US)

(21) Appl. No.: 14/501,470

(22) Filed: Sep. 30, 2014

Related U.S. Application Data
(60) Provisional application No. 61/885,265, filed on Oct. 1, 2013.

(51) Int. Cl. G09F 1/06

(52) U.S. Cl. CPC G09F 1/065
USPC 428/34.1; 428/195.1; 493/405

(57) ABSTRACT

A structure cover including a plurality of face panels formed from a blank of structure material, with each of the face panels including a tine extending therefrom. The tines are configured to be folded in an inward direction, and provide a self-adjusting stabilizing fit for the structure cover when the structure cover is placed over a structure.

### INCORPORATION BY REFERENCE

The following documents are incorporated herein by reference as if fully set forth: U.S. Provisional Application No. 61/885,265, filed Oct. 1, 2013.

### BACKGROUND

Structures, particularly vertical structures such as pylons, barriers, stakes, telephone poles, bollards and the like, have been frequently used to direct and/or prevent traffic flow into various areas. For example, in various parking lots, pylons are installed to prevent vehicles from running into buildings and other structures. These structures are somewhat unsightly and can be viewed as an eyesore.

Previous attempts to remedy the unsightliness and/or to promote various goods and/or services have included affixing small, flat signs to the structures. However, the signs are generally affixed using unsightly attachment mechanisms such as plastic zip ties that can break and cause the sign to detach from the structure. Such breakage could potentially cause damage to vehicles near the structure. In addition, the signs provide limited direct viewing from 1 side only.

Other attempts to solve this problem have included surrounding the pylon with a printed fabric sleeve. However, while the sleeves provide more viewing angles, graphics tend to be muted with the fabric printing, making them difficult for people to see. The sleeves may be expensive to produce and may have a limited outdoor life, thereby making them cost prohibitive.

### BRIEF DESCRIPTION OF THE DRAWINGS

FIG. 1 depicts a plan view of a blank for forming a structure cover according to an embodiment.

FIG. 2A depicts a plan view of an alternative blank according to an embodiment.

FIG. 2B depicts a perspective view of a fully assembled blank according to an embodiment.

FIG. 3 depicts a perspective view of a placement of a structure cover over a structure according to an embodiment.

FIGS. 4A and 4B depict a perspective view of a plurality of tines before and after a structural support cover is placed over a structure according to an embodiment.

FIG. 5 depicts a perspective view of a frictional support device surrounding a structure according to an embodiment.

FIG. 6A depicts a perspective view of an assembled alternative structure cover according to an embodiment.

FIG. 6B depicts a perspective view of an alternative structure cover surrounding a structure according to an embodiment.

FIG. 7A depicts a side view of an assembled structure cover according to an embodiment.

FIG. 7B depicts a side view of an alternative assembled structure cover according to an embodiment.

FIG. 8 depicts a plan view of a blank for forming a base cap according to an embodiment.

FIG. 9 depicts a perspective view of a base cap insertion into an assembled structure cover according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

As used herein, a “structure” refers to an object over which at least a portion is covered by a structure cover. The structure is not limited by this disclosure and may include any structure, manmade or naturally occurring, of any size and/or shape. Illustrative sizes of structures may be poles having diameters of about 2 inches to about 24 inches, including about 3 inches, about 4 inches, about 6 inches, about 8 inches, about 9 inches, about 10 inches, about 12 inches, about 15 inches, about 18 inches, about 20 inches, about 24 inches, or any value or range between any two of these values (including endpoints). In some embodiments, the structure may be a substantially vertical structure, such as, for example, a pole, a pylon, a barrier, a bollard, a stake, or the like. In some embodiments, the structure may located in or near a parking lot, a driveway, a road, or another area that is traversed by vehicles and/or pedestrians. In such embodiments, the structure may prevent vehicles from entering a certain area. In some embodiments, the structure may be permanently or semi-permanently affixed to the ground. In other embodiments, the structure may be temporarily affixed to the ground, such as, for example, a stake that is driven into the ground.

In the various embodiments described herein, a structure cover is used to provide a means for surrounding a structure. The structure cover may be visually pleasing, may contain indicia, and/or may be configured to hide at least a portion of the structure from view once the structure cover is properly positioned. The structure may also provide a 360° view of various indicia thereon such that at least a portion of the indicia may be viewed from any direction. In some embodiments, the structure cover may incorporate one or more retaining devices to ensure proper fixation to the structure and/or to prevent the structure cover from being removed from the structure, as described in greater detail herein.

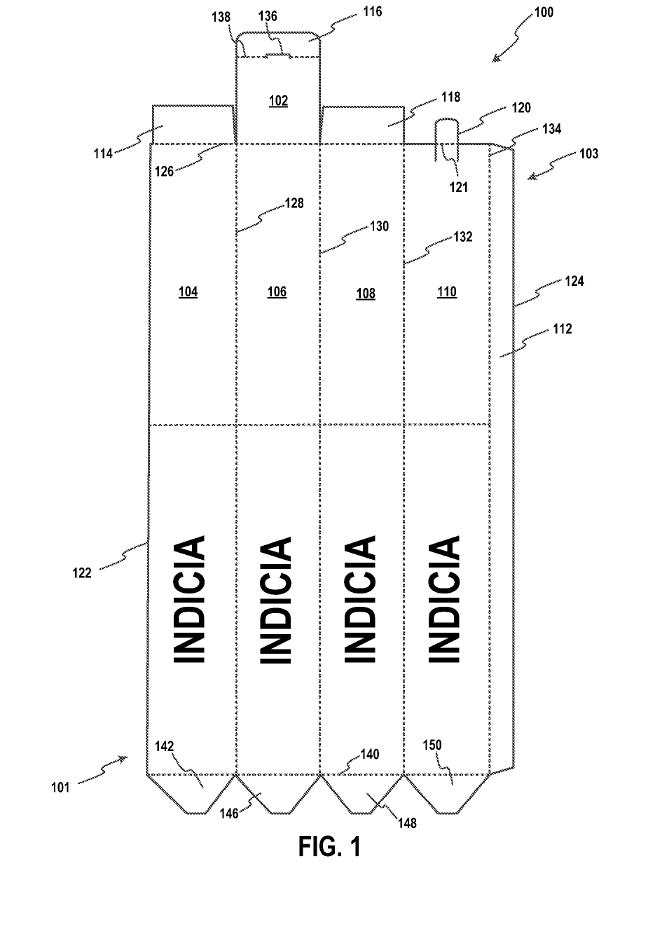

FIG. 1 depicts a plan view of a blank for forming a structure cover according to embodiment. The blank, generally designated 100, may be formed from a sheet of material by cutting the material along a plurality of edges (as illustrated by the solid lines) and scoring the material along a plurality of score lines (as illustrated by the dotted lines). Cutting and scoring the material may be completed with any device suitable for cutting and/or scoring, such as, for example, a die press apparatus. In some embodiments, the material may be a paper-based material, a polymer-based material, and/or the like. In some embodiments, the material may be corrugated. For example, one illustrative material is a corrugated flute plastic material.

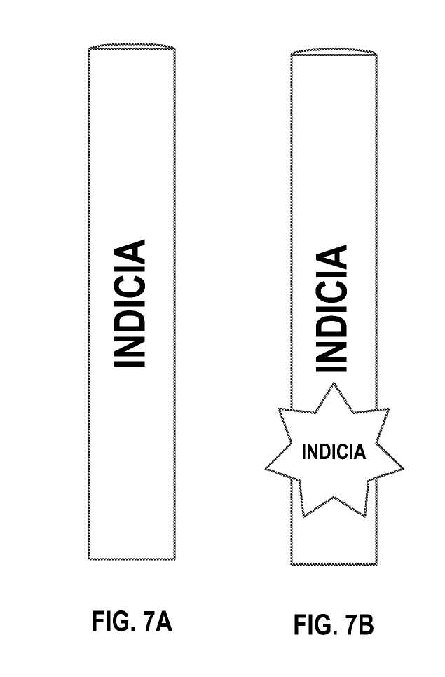

In various embodiments, the blank 100 may have a plurality of face panels 104, 106, 108, 110. The face panels 104, 106, 108, 110 may generally be formed by folding the blank 100 along score lines 126, 128, 130, 132, 134, 140. While a blank having 4 face panels is described herein, those with ordinary skill in the art will recognize that a blank may have any number of face panels, including, but not limited to, 2, 3, 4, 5, 6, 7, 8 or more face panels. In some embodiments, each of the face panels 104, 106, 108, 110 may generally face in an outward direction away from a structure that the blank 100 is configured to surround when the blank is folded at the score lines 126, 128, 130, 132, 134, 140, as described in greater detail herein. In some embodiments, one or more of the face panels 104, 106, 108, 110 may include indicia thereon. The indicia is not limited by this disclosure, and may include any images, text, various symbologies such as bar codes, quick response (QR) codes, and/or the like, graphics, various electronic displays, and/or the like. In some embodiments, the indicia may be printed directly on one or more of the face panels 104, 106, 108, 110. Printing may include, but is not limited to, screen printing, digital printing, vinyl graphic application, and/or the like. In some embodiments, the indicia may be attached to one or more of the face panels 104, 106, 108, 110 by any means of fixture, including, for example, glue, tape, adhesive, and/or the like. In some embodiments, as shown in FIG. 7B, the indicia may extend beyond the surfaces of each of the one or more face panels 104, 106, 108, 110.

Referring back to FIG. 1, in various embodiments, the blank 100 may include a tab 112. The tab 112 may generally provide a surface for attaching at least a portion of the blank 100 to form the structure cover. For example, the tab 112 may be attached to a back side of a first face panel 104 such that a box is formed with each of the face panels 104, 106, 108, 110 acting as walls. Thus, a first edge 122 may contact a score line 134 when the tab 112 is facing in an outward direction and positioned behind the first face panel 104. In some embodiments, the tab 112 may include any type of adhesive. Such an adhesive may ensure fixture of the tab 112 to the back side of the first face panel 104. The type of adhesive is not limited by this disclosure, and may include any adhesive suitable for attaching items. Illustrative examples include tape, glue, polymer adhesive, double-sided tape, and/or the like. One particular example is an all- weather, double-sided foam tape.

In various embodiments, the blank 100 may incorporate a first top flap 114, a second top flap 118, a top cover 102, a cover flap 116, and a locking tab 120. In some embodiments, the top flaps 114, 118 may generally be configured to ensure that the blank 100, when folded, retains a desired shape, such as, for example, a square shape (when viewed from a top end or a bottom end), a rectangular shape, a triangular shape, and/or the like. In some embodiments, the top flaps 114, 118 may also be configured to provide structural stability. In some embodiments, the top cover 102, the cover flap 116, and the locking tab 120 may be configured to ensure that the blank 100 retains the desired shape, to keep the blank locked in a desired configuration, and/or to provide structural stability. In some embodiments, the top cover 102 may contain indicia thereon, as described in greater detail herein. In addition, the top cover 102 may include an adhesive material to retain various indicia that are attached to the top cover.

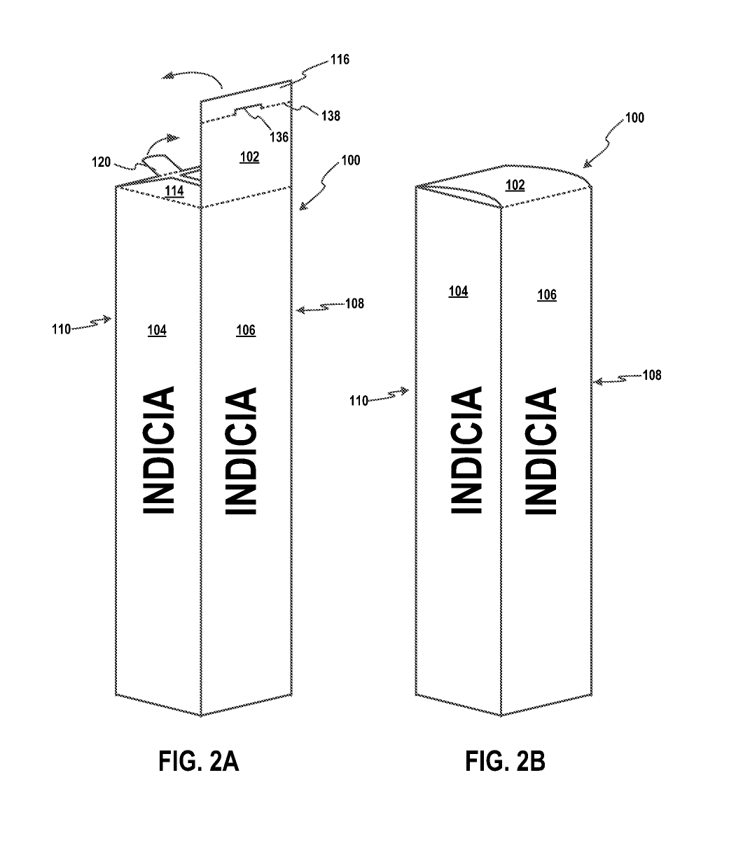

The first top flap 114 may extend from a face panel, such as, for example, the first face panel 104, and may be divided from the face panel by a score line 126. Similarly, the second top flap 118 may extend from a face panel, such as, for example, a third face panel 108, and may be divided from the face panel by the score line 126. In addition, the top cover 102 may extend from a face panel, such as, for example, a second face panel 106, and may be divided from the face panel by the score line 126. The cover flap 116 may extend from the top cover 102 and may be divided from the top cover by a cover score line 138. A center portion of the cover score line 138 may include a cut 136 along the length of the score line that allows for insertion of the locking tab 120, as described in greater detail herein. The locking tab 120 may extend from a face panel, such as, for example, a fourth face panel 110, and may be divided from the face panel by a tab score line 121. In some embodiments, such as when the blank 100 has an uneven number of face panels (such as 3 face panels), the locking tab 120 may be cut as a portion of one of the top flaps 114, 118. The score lines 121, 126, 138 may allow for the respective flaps 114, 116, 118, the cover 102, and the locking tab 120 to be folded over along the score line. As shown in FIGS. 2A and 2B, in some embodiments, when the tab 112 is affixed to the back side of the first panel 104 to create the 3 dimensional box, the first top flap 114 and the second top flap 118 may be folded in such that they face each other. In addition, the top cover 102 may be folded over the first top flap 114 and the second top flap 118 such that the cover flap can be tucked between the top flaps and the fourth panel 110. The locking tab 120 may then be inserted into the cut 136 so as to retain the top cover 102 in a closed position over the top flaps 114, 118.

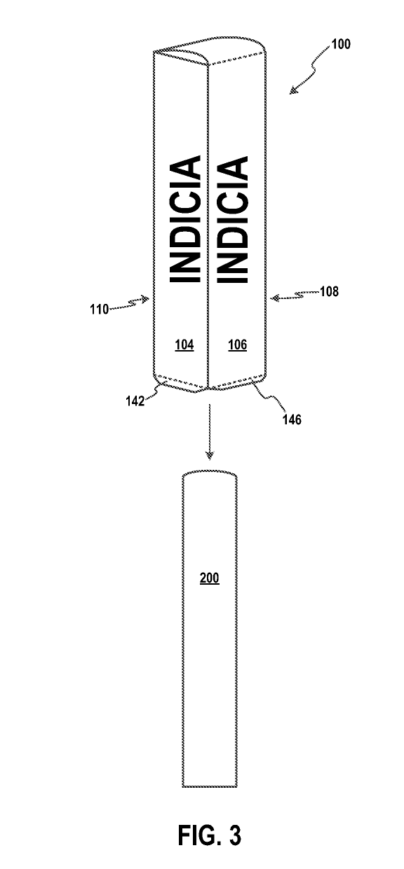

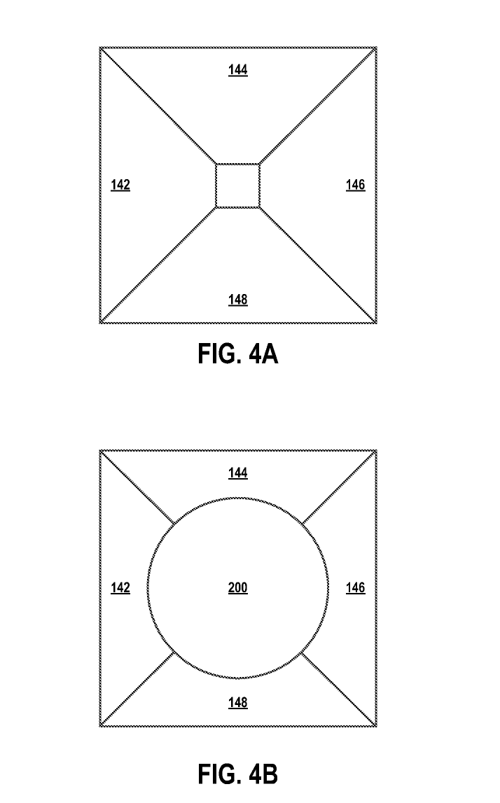

Referring back to FIG. 1, the blank 100 may include one or more tines 142, 146, 148, 150. The tines 142, 146, 148, 150 may be configured to provide a self-adjusting stabilizing fit for the structure cover when it is placed over a structure. The tines 142, 146, 148, 150 may be defined by a score line 140 that separates each tine from its respective face panel 104, 106, 108, 110. When the blank 100 is folded in the manner described herein, the tines 142, 146, 148, 150 may be folded inward such that the tines face each other, as depicted in FIG. 4A. Accordingly, as depicted in FIG. 3, when the structure cover is placed over the structure 200, the tines will be pushed further inward by the structure (see FIG. 4B) and will act to retain the structure cover over the structure. The tines 142, 146, 148, 150 may be at any location on the blank 100. For example, in some embodiments, the tines 142, 146, 148, 150 may be located at or near a bottom portion 101 of the blank 100. In other embodiments, the tines 142, 146, 148, 150 may be located at or near a top portion 103 of the blank 100.

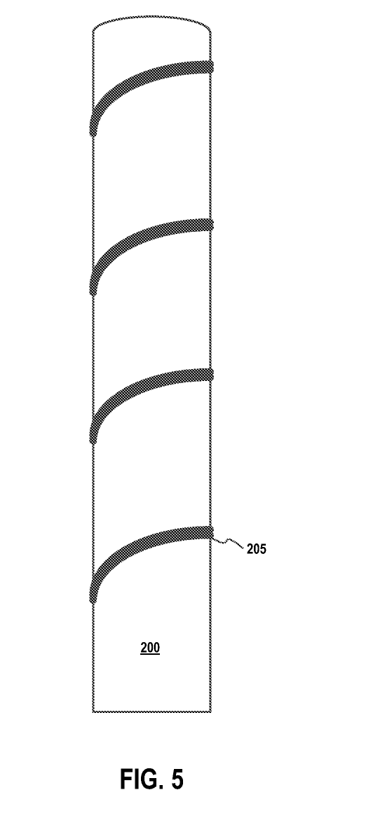

Referring to FIG. 5, in various embodiments, the structure 200, prior to receiving the structure cover, may be covered in part by a frictional support device 205. The frictional support device 205 may generally be configured to ensure a firm attachment of the structure cover to the structure 200. Thus, with the frictional support device 205, external forces such as wind or the like will be prevented from dislodging the structure cover from the structure 200. In some embodiments, the frictional support device 205 may act to provide a true vertical orientation of the structure cover over the structure 200. In some embodiments, the frictional support device 205 may cover the entire structure 200. In other embodiments, the frictional support device 205 may cover only a portion of the structure 200. In yet other embodiments, the frictional support device 205 may be affixed to a back side of the blank 100 (FIG. 1) such that, when the blank is folded as described herein, the frictional support device will be located on various inside walls of the structure cover. In some embodiments, the frictional support device 205 may be located at or near a top portion of the structure 200 such that, when the structure cover is placed over the structure, the frictional support device may provide a compressive tension between the structure and the structure cover. In particular embodiments, such compressive tension may be provided before the top flap portion of the structure cover is closed. The frictional support device 205 is not limited by this disclosure, and may include any materials capable of providing attachment of the structure cover to the structure 200. In some embodiments, the frictional support device 205 may be or include any number of adhesives, tapes, glues, polymers, foams, and/or the like. In particular embodiments, the frictional support device 205 may be a strip of compressible foam that is wrapped around the structure 200. The strip of compressible foam may be, for example, about 0.5 inches thick, about 2 inches wide, and about 24 inches long in an uncompressed state.

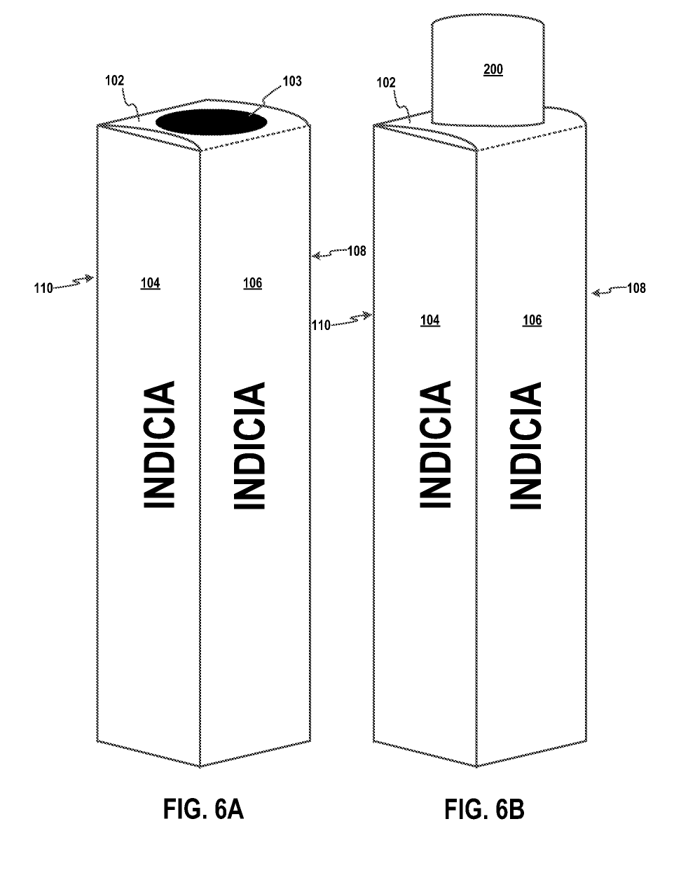

FIGS. 6A and 6B depict an alternate embodiment in which the top cover 102 includes an opening 103 for at least a portion of the structure 200 to pass therethrough. Such a structure cover may be necessary in instances where the structure 200 is too large to contain the entire structure cover. Those with ordinary skill in the art will recognize that while the top cover 102 is depicted as having the opening 103 for the structure 200 to extend therethrough, any portion of the structure cover may contain the opening. Thus, the location and number of opening(s) 103 is not limited by this disclosure. Furthermore, the shape of the opening 103 is not limited by this disclosure, and may be any shape and/or size. The shape and/or size may be a shape and/or size that is suited for the shape of the structure 200 that is to protrude from the structure cover. Thus, in the present example where the structure 200 is substantially cylindrical, the opening 103 is round and sufficiently sized to allow the structure to protrude therethrough. In some embodiments, the opening 103 may be formed by cutting a hole in the blank 100 (FIG. 1). In other embodiments, particularly in embodiments where it is not known whether the opening 103 may be needed, the opening may be formed by cutting one or more perforations in the blank 100 (FIG. 1), which can then be used to punch out the opening 103 to fit the size, shape, and location of the protruding structure 200.

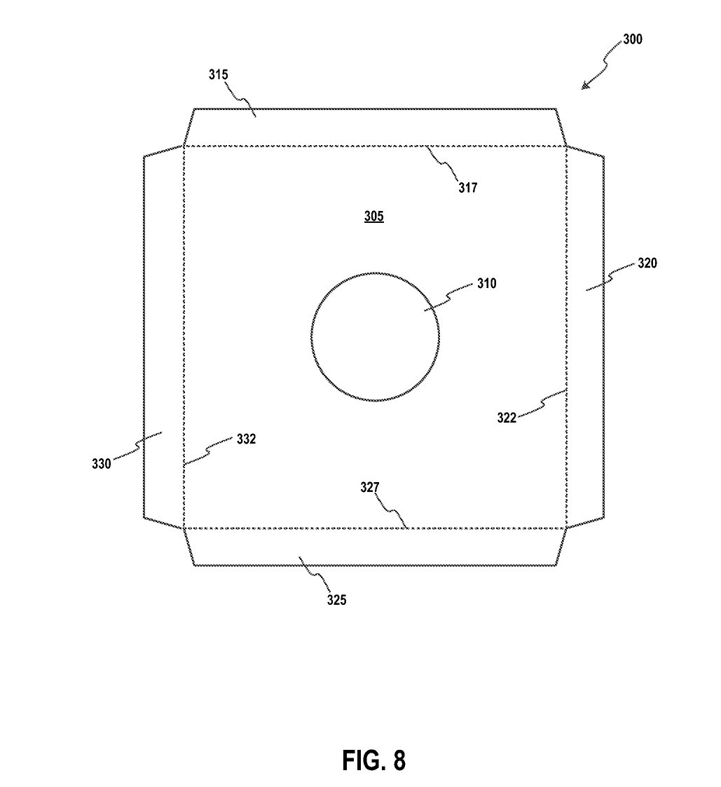

In various embodiments, it may be desirable to place the structure cover in an area where there is no structure to cover. In such embodiments, a stake may be used to support the structure cover in a standing position. Such a stake is not limited by this disclosure, and may include any shape, size, and composition of stake. In particular embodiments, the stake may be about 4 feet tall, such as a stake that is commonly used for temporary signage. In some embodiments, the stake may be smaller in size than a typical structure such as a pylon. Accordingly, it may be necessary to form a base cap 300 to support the structure cover on the stake, as shown in FIG. 8.

In various embodiments, the base cap 300 may have a base surface 305 and a plurality of base tabs 315, 320, 325, 330. In some embodiments, the base cap 300 may be made of a material that is similar to that of the blank 100 (FIG. 1). Such a material may allow for the blank and the base cap 300 to be cut from the same piece of starting material. Thus, the base cap 300 may be made of a paper-based material, a polymer-based material, and/or the like. In some embodiments, the material may be corrugated. For example, one illustrative material is a corrugated flute plastic material. In other embodiments, the base cap 300 may be made of a material that is different than the material used for the blank 100 (FIG. 1). The material may be different because, for example, the base cap 300 may require a heavier, more expensive material than the blank 100 (FIG. 1) to ensure a proper support on the stake. Such a material may not be necessary for use on the blank 100 (FIG. 1) and thus the cost of fabricating the various pieces may be kept at a minimum by fabricating the base cap 300 of a different material. In some embodiments, the base cap 300 may be fabricated via any method of fabrication and with the use of any devices, such as, for example, a die press apparatus.

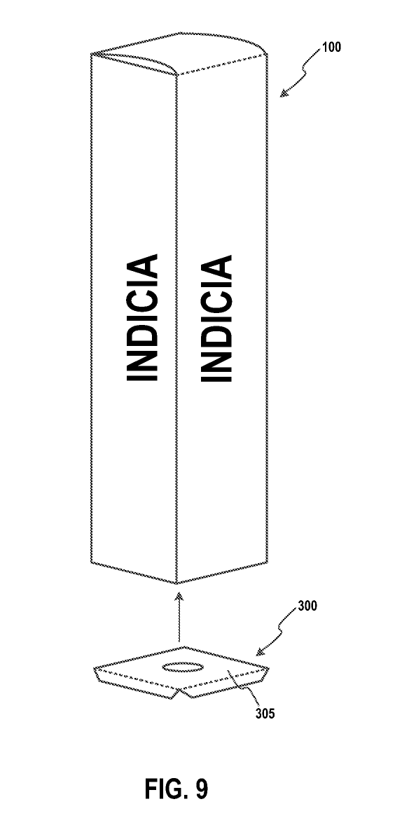

In various embodiments, the base surface 305 may have a length and a width that corresponds to a size that is slightly smaller than a width of each of the face panels 104, 106, 108, 110 of the structure cover such that, when the base cap 300 is inserted into the assembled structure cover, it will fit snugly inside the assembled structure cover, as shown in FIG. 9. Referring back to FIG. 8, the base surface 305 may have an opening 310 configured to receive the stake therethrough. The opening 310 may generally be of a size and a shape that is suitable to receive the stake. For added support, the opening 310 may be sized and shaped such that the stake fits snugly within the opening, thereby providing additional support for the structure cover when it is placed on the stake.

In some embodiments, a size and a number of base tabs may correspond to the number of walls (i.e., the number of face panels) in the structure cover. Thus, a base cap 300 that corresponds to a structure cover having four walls (such as the structure cover depicted in FIG. 1) may have four base tabs 315, 320, 325, 330 that have a substantially similar length to that of the width of each wall of the structure cover. In some embodiments, the base tabs 315, 320, 325, 330 may each extend from the base surface 305 and may each be defined from the base surface by a respective score line 317, 322, 327, 332. The score lines 317, 322, 327, 332 may extend between two edges of the base surface such that the respective base tab 315, 320, 325, 330 can be folded at the score line to which it corresponds.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into sub-ranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A structure cover comprising:
a plurality of face panels formed from a blank of structure material; each of the face panels including a tine extending therefrom, wherein the tines are configured to be folded in an inward direction,
wherein the tines provide a self-adjusting stabilizing fit for the structure cover when the structure cover is placed over a structure.

2. The structure cover of claim 1, wherein the panels are folded together to form a structure receiving enclosed area.

3. The structure cover of claim 1, wherein the tines are located at a bottom portion of the structure cover.

4. The structure cover of claim 1, further comprising a frictional support device configured to surround the structure.

5. The structure cover of claim 4, wherein the frictional support device provides a snug fit for the structure cover over the structure at a top portion of the structure and wherein the tines provide a snug fit for the structure cover at a bottom portion of the structure.

6. A method of fabricating a structure cover, the method comprising:
forming a structure cover from a blank of structure material, wherein the structure cover comprises a plurality of face panels; and a tine extending from each of the face panels; and
folding the tine in an inward direction to provide a self-adjusting stabilizing fit for the structure cover when the structure cover is placed over a structure.
